(19) United States
(12) Patent Application Publication
(10) Pub. No.: US 2012/0227550 A1
(43) Pub. Date: Sep. 13, 2012

(54) Torque Bar

(76) Inventors: Aaron Mark Belanger, Okemos, MI (US); Peter J. Poletes, Okemos, MI (US)

(21) Appl. No.: 13/046,538

(22) Filed: Mar. 11, 2011

(51) Int. Cl. B25B 23/16; B25G 1/04

(52) U.S. Cl. 81/177.2

(57) ABSTRACT

A torque bar that can be used with wrenches, ratchets, itself, and alike to permit the user to reduce strain to one's self; or increase the leverage applied to a tool in loosening a fastener, torque for tightening, or avoiding obstacles. Both components of the assembly can be used as individual pieces or combined for extra length or even more increased leverage as desired.

### REFERENCES CITED

U.S. patent Documents

| | | |
|---|---|---|
| 5,570,617 | October 1996 | Love |
| 5,109,737 | May 1992 | Raber |
| D510,694 | October 2005 | Giles, Jr. et. |
| D377,745 | Feburary 1997 | Laun |
| 4,581,958 | April 1986 | Shull |
| 4,691,599 | September 1987 | Schultz |

### STATEMENT REGARDING FEDERALLY SPONSORED RESEARCH OR DEVELOPMENT

Not Applicable

### REFERENCE TO SEQUENCE LISTING

Not Applicable

### BACKGROUND OF THE INVENTION

The invention relates generally to hand tools, and more particularly relates to handle extensions for hand operated ratchets, wrenches and alike.

A number of United States Patents have been issued for tools which engage hand tools or extend tool handles. The following are examples of such patents.

U.S Pat. No. 5,570,617 describes an extension handle with a closed end, stabilizer clamping end and telescoping handle.

U.S. Pat. No. 5,109,737 provides a ratchet with a fixed sleeved handle with spring or spring steel loaded detent.

U.S. Pat. No. D510,694 shows an ornamental design for a one piece extension handle for a ratchet wrench.

U.S. Pat. No. D377,745 shows an ornamental design for a tool handle extender.

U.S. Pat. No. 4,581,958 has an extensible handle assembly for ratchet wrench or the like relying on a ball and groove locking mechanism.

U.S. Pat. No 4,691,599 details a lug wrench extension handle using indentations to grip the tapered end of the wrench.

### SUMMARY OF THE INVENTION

It is the general objective of the invention to provide for a two component device that can be engaged individually or configuratively to the strain exerting portion of multiple size ratchet, wrench, or hand tools.

It is an object of the invention to provide the user with an improved torque bar that reduces the force strength needed to operate the strain exerting portion of a ratchet, wrench, or hand tool during use.

It is further object of the invention to provide an improved extension to the ratchet, wrench or hand tool's strain exerting portion to reach otherwise inaccessible locations in engine compartments in automotive repair and assembly operations as well as similar situations involving other types of equipment.

It is also an object of the invention to provide for an improved torque bar allowing the user to grip the ratchet, wrench, or hand tool in a position removed from the immediate vicinity of the work area such that the user's hand is not subject to injury if the ratchet slips or fails causing the user's hand to impact the equipment.

It is an additional objective of the invention to provide for variable length extenders to the strain exerting portion of ratchets, wrenches, and hand tools to accomplish the improvements embodied in this invention.

It is also an object of the invention to provide an improved torque bar which has a removable user selected extension to accomplish the improvements embodied in the invention.

### DESCRIPTION OF THE DRAWINGS

The following drawings illustrate the preferred embodiment of the invention as well as alternative embodiments.

FIG. 1 is an overhead view of a torque bar et b g the features of the first configuration of the invention.

FIG. 2 is an overhead view of a torque bar embodying the features of the second configuration of the invention.

FIG. 3 is an overhead view of a torque bar's straight component.

FIG. 4 is a longitudinal cross section of a torque bar's straight component.

FIG. 5 is an overhead view of a torque bar's curved component.

FIG. 6 is a longitudinal cross section of a torque bar's curved component.

FIGS. 7a and 7b are a cross-section view of a torque bar's engaging sleeve ends when the two components are engaged in either configuration.

### DESCRIPTION OF THE PREFERRED EMBODIMENT

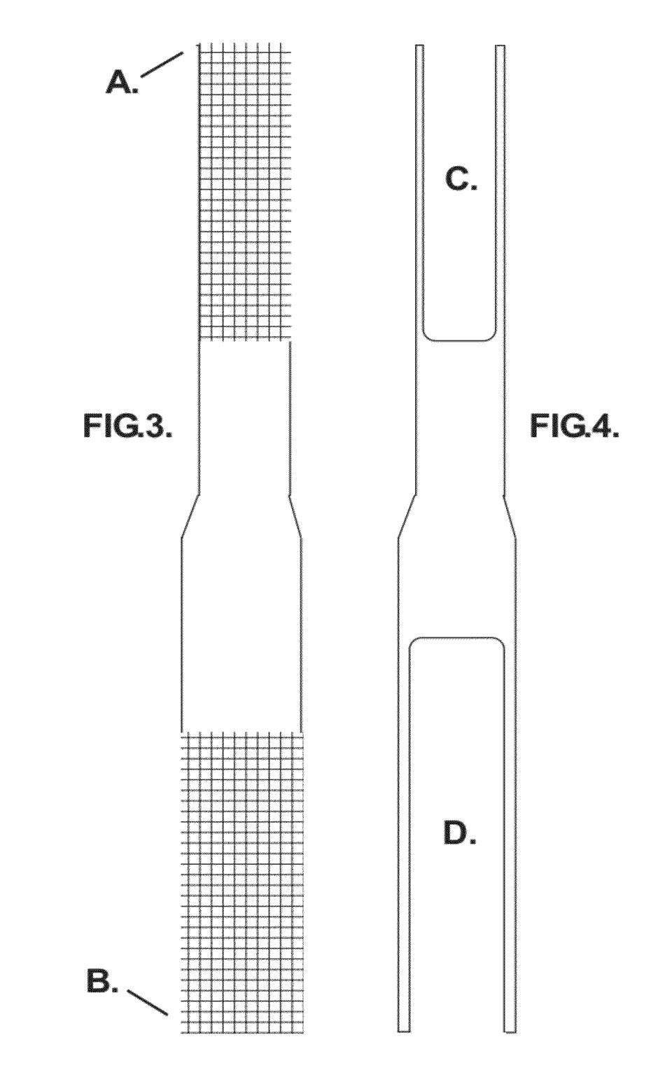

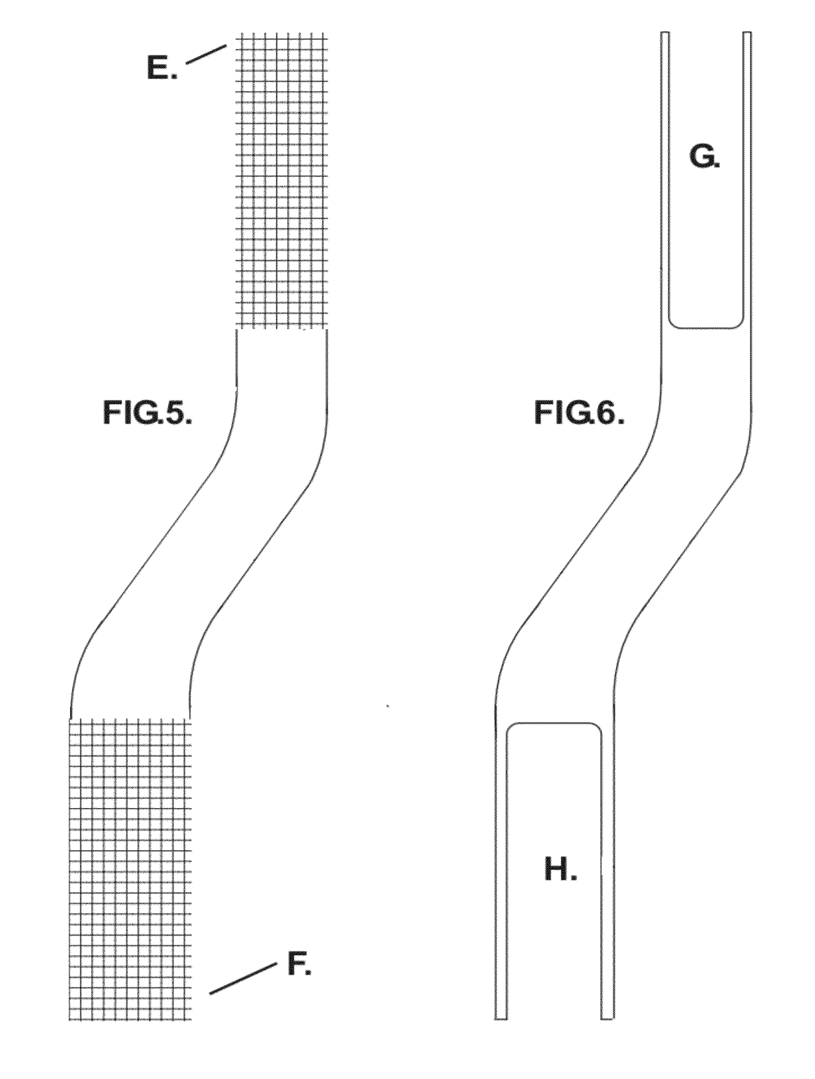

The torque bar is a two component FIG. 3 and FIG. 5 invention that allows the user two combined and two individual uses by the invention.

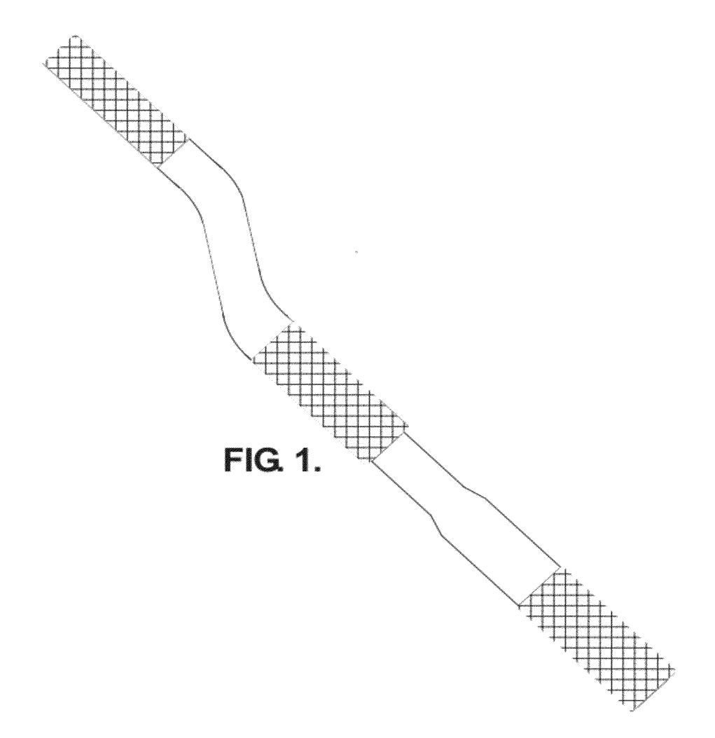

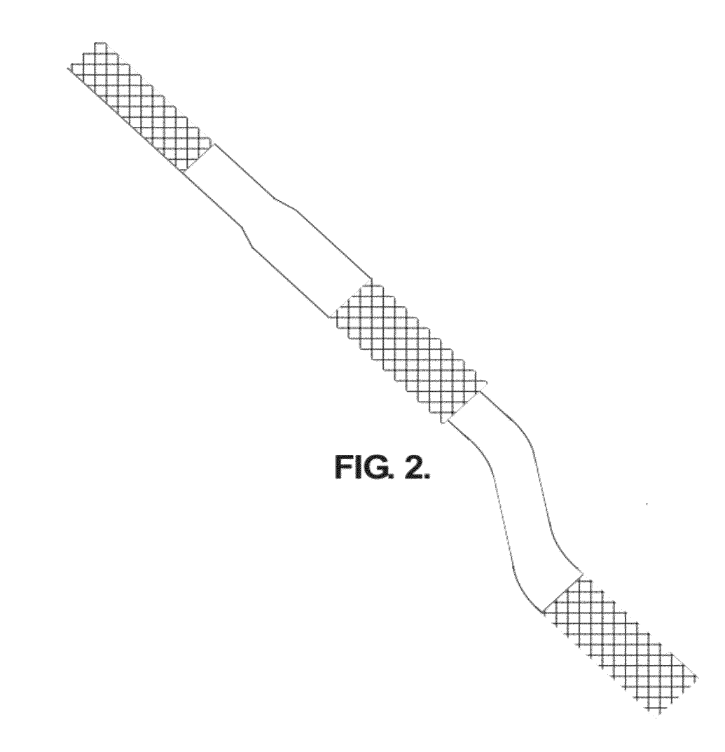

FIG. 1 and FIG. 2 illustrate the two combined configurations of the two components FIG. 3 and FIG. 5.

FIG. 3 illustrates the tubular exterior of the straight component with two different end widths and a tapered shank midway down the shaft of the torque bar. It also illustrates having the strain exerting portions (A.) and (B.) of the torque bar textured by either knurling, or coating to provide either grip for the user's hand or to enhance grip to the other component when engaged.

FIG. 5 illustrates the tubular exterior of the curved component: with two different end widths and a graduated shank along the curves of the torque bar. It also illustrates having the strain exerting portions (E.) and (E) of the torque bar textured by either knurling, or coating to provide either grip for the user's hand or to enhance grip to the other component when engaged.

FIG. 4 illustrates a longitudinal cross-section view of the straight component of the torque bar with partially sleeved cavities C. and D. with each cavity having a different cavity diameter and depth.

FIG. 6 illustrates a longitudinal cross-section view of the curved component of the torque bar with partially sleeved cavities G and H. with each cavity having a different cavity diameter and depth.

Depending on the size of the strain exerting portion of a ratchet, wrench, or hand tool; either of the cavitied C., D., G., or H. portions of either component of the torque bar components may be used to insert the ratchet, wrench, or hand tool. All interior cavity walls may be textured or coated to enhance grip to the other component or the strain exerting portion of a ratchet, wrench, or hand tool.

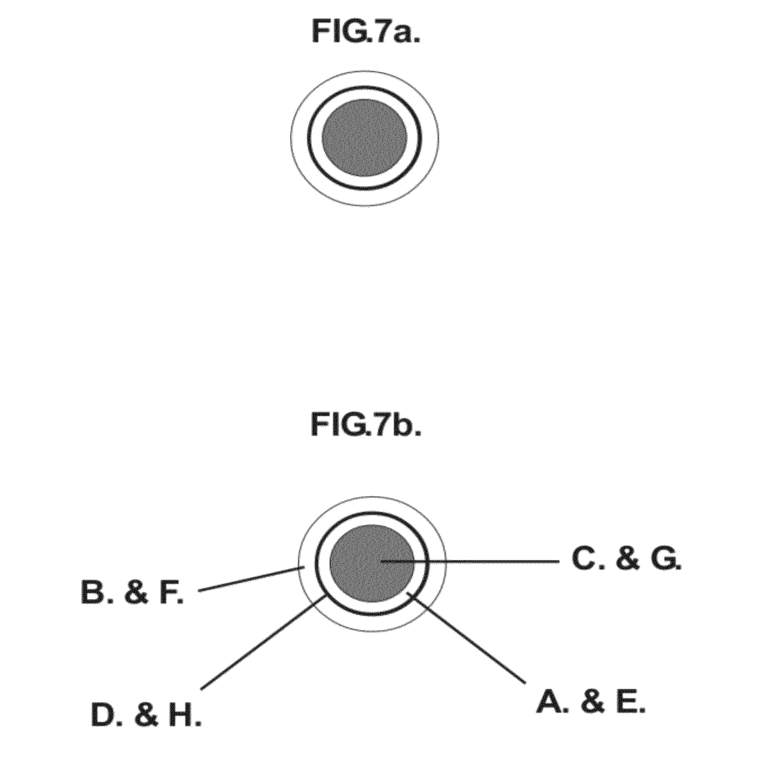

FIG. 3 and FIG. 5 have corresponding, matching cavity sleeve diameters and cavity depths, with the smaller diameter portion designed to be inserted and engage the larger diameter sleeve as shown in cross-section FIG. 7a.

7b shows the matching, corresponding portion ends and sleeved cavities of both components of the torque bar when both components are engaged together as shown in either FIG. 1 or FIG. 2.

While the invention has been described above with reference to the preferred embodiment, it will be understood that various changes and modifications may be made without departing from the spirit and scope of this invention.

What we claim is:

1. The torque bar is an engagable two piece handle extension with forward and rearward partial sleeves to be slid over the strain exerting portion of a ratchet, wrench, or hand tool, or each other.

2. The tool as described in claim 1. can be used as individual pieces or combined to create one longer length tool.

3. The tool as described in claim 1 in which said handle extension comprises of two solid cylinders; one component cylinder straight with a tapered shoulder midway down cylinder and both ends partially sleeved, and one component cylinder curved with graduated thickness through the shank with both ends partially sleeved.

4. The tool as described in claim 3 in which said handle extension sleeves are dimensioned to closely tit into each tools said component's opposite tool end.

5. The tool as described in claim 3 in which said handle extension means and said partial sleeve are knurled or texturally coated on the outside.

6. The tool as described in claim 3 in which said handle extension means and said partial sleeve are knurled or texturally coated on the inside.
